(19) United States
(12) Patent Application Publication
(10) Pub. No.: US 2021/0267146 A1
(43) Pub. Date: Sep. 2, 2021

(54) Plant pot cover system

(71) Applicant: MILLERRY DESIGNS LLC, Dixie, GA (US)

(72) Inventors: Barbara J. Miller, Dixie, GA (US); Donald W. Miller, Dixie, GA (US)

(21) Appl. No.: 16/805,725

(22) Filed: Feb. 29, 2020

(51) Int. Cl. A01G 27/02; A01C 23/02; A47G 7/04; A01G 13/02

(52) U.S. Cl. CPC A01G 27/02; A01G 13/02; A47G 7/045; A01C 23/02

(57) ABSTRACT

A plant pot cover system, includes a plant pot cover body; a plurality of cover clips; a belt; a watering ring, including a hollow tube with a fertilizer agent inside, a slip tee fitting with an entry aperture, a plurality of adjustable drip fittings, such that the plant pot cover body can be pulled over a plant pot, such that a fertilized water solution drips from the hollow tube into an interior of the plant pot.

### CROSS-REFERENCE TO RELATED APPLICATIONS

N/A.

### FIELD OF THE INVENTION

The present invention relates generally to the field of accessories for plant pots, and more particularly to methods and systems for plant pot covers with attached accessories.

### BACKGROUND OF THE INVENTION

Plant pots for use in the home or garden are popular and are readily available at home improvement and gardening centers.

However, such plant pots, including hanging flowerpots, are typically made of plastic and are often aesthetically unappealing.

As such, considering the foregoing, it may be appreciated that there continues to be a need for novel and improved devices and methods for covering flowerpots.

### SUMMARY OF THE INVENTION

The foregoing needs are met, to a great extent, by the present invention, wherein in aspects of this invention enhancements are provided to the existing model of plant pot covers with attached accessories.

In an aspect, a plant pot cover system can include:
a) plant pot cover body, which is made from a flexible material, wherein the plant pot cover body can include:
   i. a sleeve portion, which can be tubular; and
   ii. a bottom portion, which closes the bottom end of the sleeve portion;
such that the plant pot cover body is configured to be pulled over a plant pot, such that the sleeve portion covers the side of the plant pot.

In a related aspect, the plant pot cover system can further include:
a) a plurality of cover clips, wherein each cover clip comprises a main clip portion, such that the main clip portion clips over a rim of the plant pot, such that the main clip portion holds an upper edge area of the plant pot cover body in position on the rim of the plant pot.

In another related aspect, the plant pot cover system can further include:
a) a watering ring, which can comprise:
   i. A hollow tube, which can be made from a flexible plastic material;
   wherein the watering ring is held by the cover clips on an inner side of the rim of the plant pot;
   such that a water solution can drip from the hollow tube, via drip apertures of the hollow tube.

In a further related aspect, the watering ring can be configured as a fertilizer ring, wherein the watering ring can further include:
a) a solid fertilizing agent, which is positioned inside the hollow tube;
whereby the solid fertilizing agent gradually dissolves in the water solution, such that the water solution fertilizes a plant, which is planted in the plant pot.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a side view of a plant pot cover system, according to an embodiment of the invention.

FIG. 1B is a bottom view of a plant pot cover system, according to an embodiment of the invention.

FIG. 2A is a side view of an inner lining sleeve, according to an embodiment of the invention.

FIG. 2B is a bottom view of an inner lining sleeve, according to an embodiment of the invention.

FIG. 3A is a side view of a cover clip, according to an embodiment of the invention.

FIG. 3B is a side view of a cover clip, according to an embodiment of the invention.

FIG. 4A is a cross-sectional side view of a plant pot cover system, according to an embodiment of the invention.

FIG. 4B is a top view of a plant pot cover system, according to an embodiment of the invention.

FIG. 5A is a top view of a watering ring, according to an embodiment of the invention.

FIG. 5B is a bottom view of a watering ring, according to an embodiment of the invention.

FIG. 6A is a side view of a plant pot cover system, according to an embodiment of the invention.

FIG. 6B is a side view of a plant pot cover system, according to an embodiment of the invention.

FIG. 7A is a side view of a plant pot cover system, according to an embodiment of the invention.

FIG. 7B is a side view of a plant pot cover system, according to an embodiment of the invention.

FIG. 8A is a bottom view of a fertilizer ring, according to an embodiment of the invention.

FIG. 8B is a bottom view of a fertilizer ring, according to an embodiment of the invention.

FIG. 9 is a side view of a plant pot cover system, according to an embodiment of the invention.

FIG. 10 is a perspective view of a plant pot cover system, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

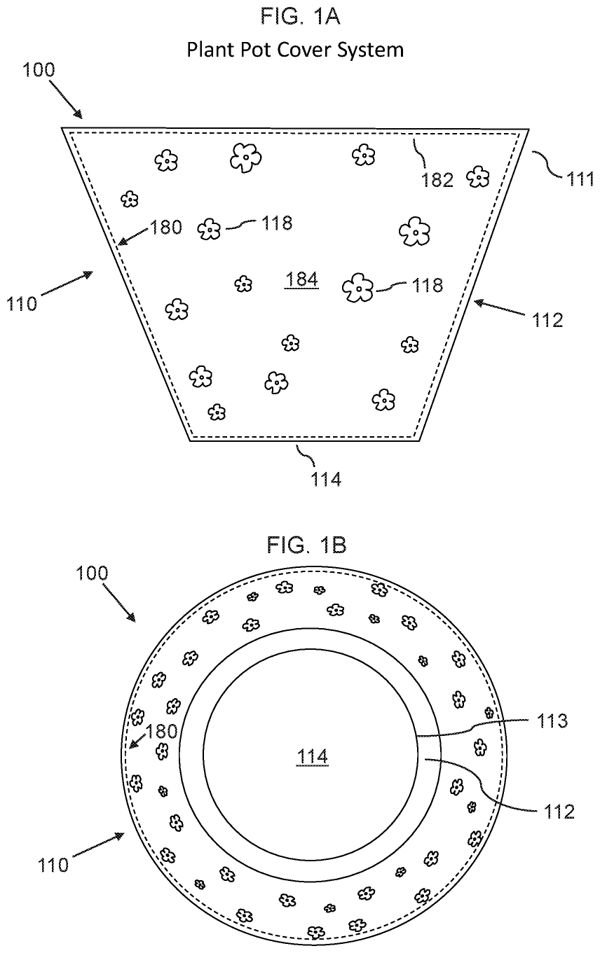

In the following, we describe the structure of an embodiment of a plant pot cover system 100 with reference to FIG. 1A, in such manner that like reference numerals refer to like components throughout; a convention that we shall employ for the remainder of this specification.

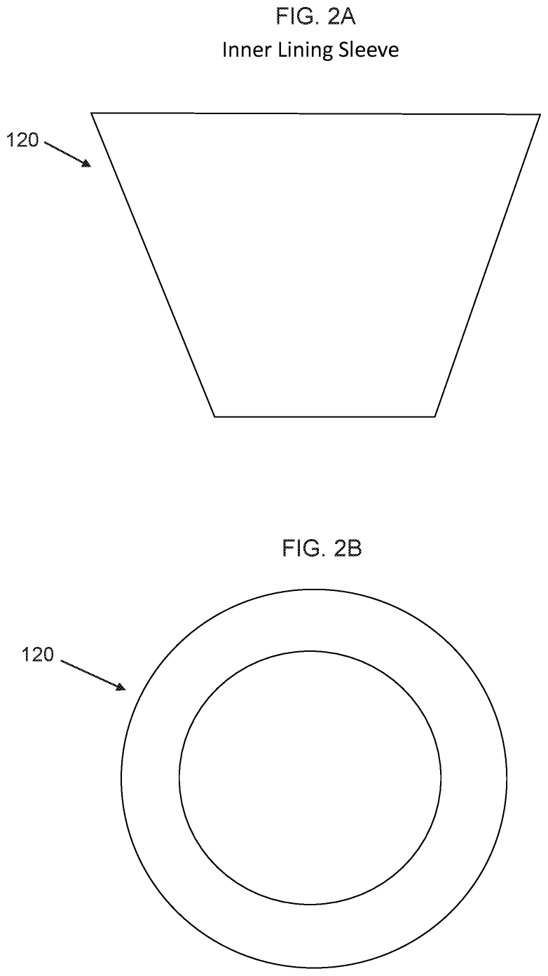

In an embodiment, as shown in FIGS. 1A and 1B, a plant pot cover system 100 can include:
a) plant pot cover body 110, which is made from a stretchable material (which can also be referred to as an elastic or expandable material), wherein the plant pot cover body 110 can include:
   i. a sleeve portion 112, which can be tubular; and
   ii. a bottom portion 114, which is connected to a bottom end 113 of the sleeve portion 112, to close the bottom end 113 of the sleeve portion 112;
such that the plant pot cover body 110 is configured to be pulled over a plant pot 180, such that the sleeve portion covers the side of the plant pot 180, and such that the bottom portion 114 covers a bottom of the plant pot. FIG. 2A shown an example where a lower part of the sleeve portion 112 has been stretched over a bottom edge of the plant pot 180.

In related embodiments, the plant pot cover system 100 can be used for decorating unsightly plastic flowerpots 180. The plant pot cover body 110 can be made from an expandable/stretchable and flexible fabric, which can be decorated with colorful images, text or designs, and has a closed bottom, such that the plant pot cover body 110 can be pulled upward and over a lip of the outside of the pot 180. The fabric of the plant pot cover body 110 can disguise the bland plastic pot options available at most home improvement centers. The plant pot cover body 110 can also be described as straight-sock-shaped, or bag-shaped, such that the plant pot cover body 110 includes a sidewall portion 112 and a bottom portion 114.

In an example embodiment, the plant pot cover body 110 can include flower images 118, which are randomly placed on a colorful fabric 112.

In another related embodiment, the plant pot cover body 110 can be coated with an antimicrobial coating, which includes an antimicrobial agent, such as a chemical composition, to help keep mildew and other fungi from forming and harming the live plant, whereby the antimicrobial coating inhibits growth of fungi and bacteria.

In another related embodiment, the stretchable/expandable fabric material of the plant pot cover body 110 can be woven/knitted from threads/fibers, which include:
a) elastane, i.e. a polyether-polyurea copolymer, also known as LYCRA™ or SPANDEX™;
b) polyester, including polyethylene terephthalate;
c) other elastic materials; or
d) a combination/blend of these.

In another related embodiment, as shown in FIGS. 2A and 2B, the plant pot cover system 100 can further include:
a) an inner lining sleeve 120, which can be waterproof, such that is not penetrable by water, or water resistant, and can be made of plastic, which can be a transparent flexible plastic sheet;
such that the inner lining sleeve 120 is positioned between the plant pot cover body 110 and the plant pot 180, in order to waterproof the plant pot cover system 100.

In related embodiments, the plant pot cover body 110 can be held in place on the plant pot 180 by a friction of the stretchable fabric of the plant pot cover body 110 against a surface of the plastic pot 180.

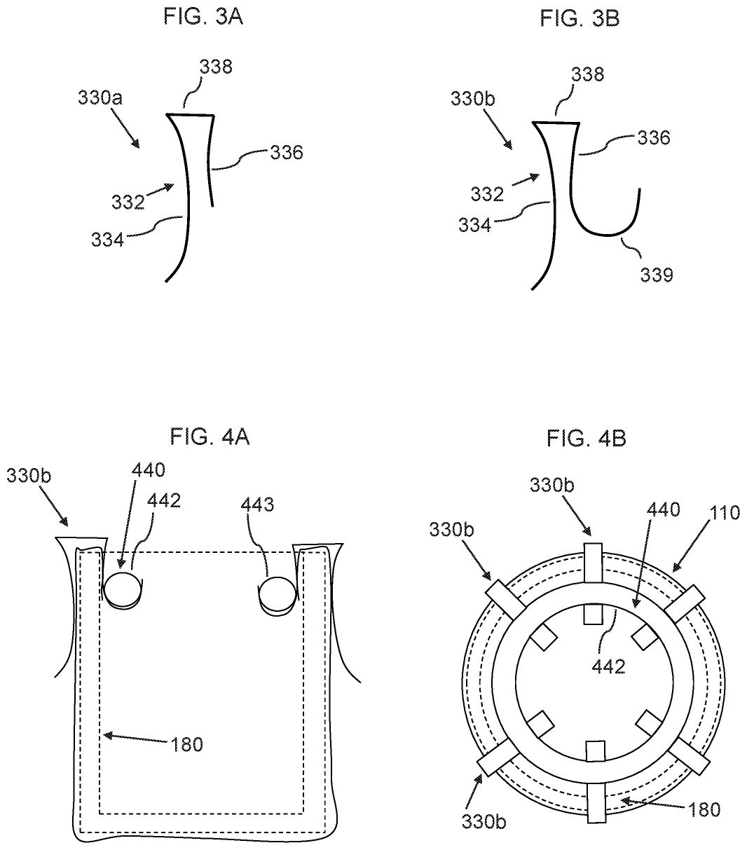

In another related embodiment, as shown in FIGS. 3A, 3B, and 4A, the plant pot cover system 100 can further include:
a) a plurality of cover clips 330a, which can be made of plastic, wherein each cover clip comprises a main clip portion 332, which can be substantially downward u-shaped (soft curved or rectangular), such that the main clip portion 332 is configured to clip over a rim 182 of the plant pot 180, such that the main clip portion holds an upper edge area 111 of the plant pot cover body 110 in position on a rim 182 of the plant pot 180, which also serves to ensure that the upper edge area 111 of the plant pot cover body 110 (or specifically of the sleeve portion 112) does not come in contact with a plant, that is planted in the plant pot 180. As shown in FIGS. 4A and 10, the upper edge area 111 of the plant pot cover body 110 can fold back over an inside of the of plant pot 180.

In another related embodiment, the main clip portion 332 can further include:
a) an outer clip flange 334;
b) an inner clip flange 336; and
c) a clip bridge 338;
such that a top end of the outer clip flange 334 can be connected with a top end of the inner clip flange 336;
such that the clip bridge 338 connects a top end of the outer clip flange 334 with a top end of the inner clip flange 336.

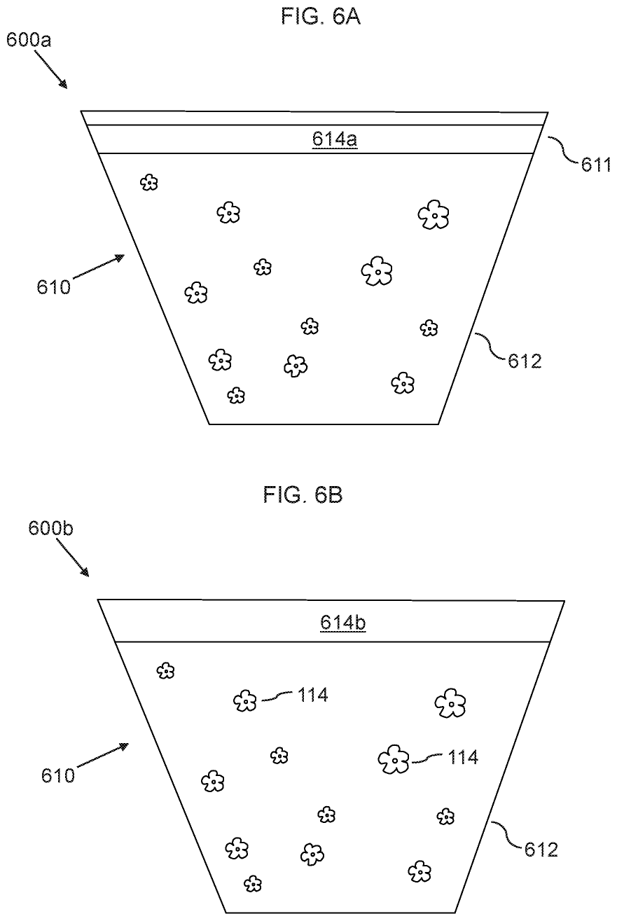

In another related embodiment, as shown in FIGS. 6A and 6B, the sleeve portion 612 of the plant pot cover body 610 can further include:
a) a belt 614a, which is a strengthened peripheral portion of the upper edge area 611 of the sleeve portion 612, which for example can be made by folding back material to form a stitched hem 614b, which can be a single- or double-fold hem 614b; i.e. the belt 614b is a stitched hem 614b, which comprises a folded back portion of the stretchable material. The belt 614a, 614b can be made from a coordinating material or can be made from the same single piece of fabric used for the sleeve portion 612 of the plant pot cover body 610 of the plant pot cover system 600a, 600b.

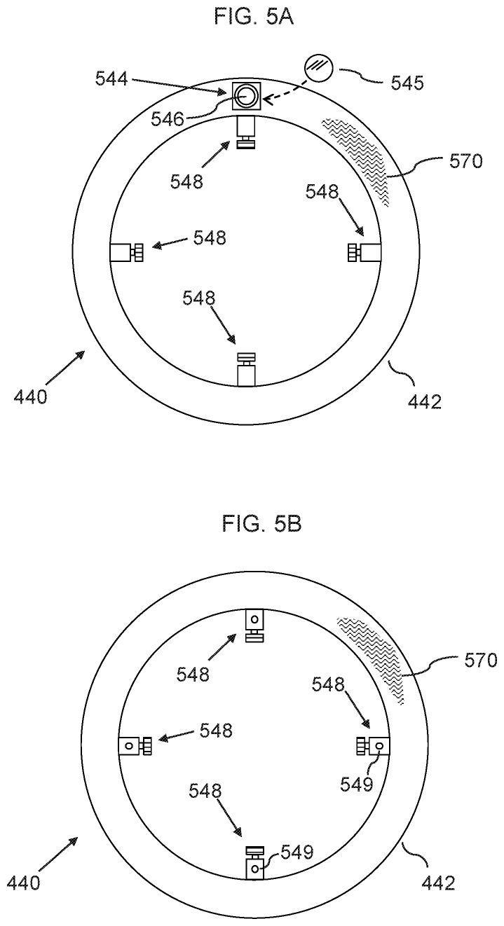

In another related embodiment, as shown in FIGS. 4A, 4B, 5A, and 5B, the plant pot cover system 100 can further include:
a) a watering ring 440, which can comprise:
   i. A hollow tube 442, which is configured to contain a water solution 570, wherein the hollow tube 442 comprises a plurality of drip apertures 549, wherein the hollow tube 442 can be made from a flexible plastic material, and wherein the hollow tube 442 can be ring-shaped;
   ii. A slip tee fitting 544, which includes an entry aperture 546 and a cap 545 for closing the entry aperture 546, wherein the slip tee fitting 544 is mounted on the hollow tube, such that a water solution 570 can be filled into the hollow tube 442 via the entry aperture 546 of the slip tee fitting 544; and
   iii. a plurality of adjustable drip fittings 548, which are positioned in the hollow tube 442, wherein each adjustable drip fitting 548 includes a corresponding drip aperture 549 in the plurality of drip apertures 549;
   wherein the watering ring 440 can be configured to connect to the rim 182 of the plant pot 180 on an inner side of the rim 182 of the plant pot 180;
   wherein each cover clip 330b in the plurality of cover clips 330b comprises a ring clip portion 339, which can be upward u-shaped, such that the a ring clip portion 339 is connected to the main clip portion 332, such that the ring clip portion 339 protrudes inward from the main clip portion 332, such that the ring clip portion 339 is configured to hold a segment 443 of the watering ring 440, such that the cover clips 330b are positioned around the rim, whereby the cover clips 330b are configured to hold the watering ring 440, such that the watering ring 440 is held away from soil in the plant pot 180, and does not interfere with hanger wires/arms of a hanging plant pot 180; such that the water solution 570 can drip from the hollow tube 442, via the drip apertures 549 of the adjustable drip fittings 548, into an interior 184 of the plant pot 180. The water solution 570 can drip for a predetermined period of time, such as one, two, or three days, depending on settings of the adjustable drip fittings 548, before the hollow tube 442 has to be refilled.

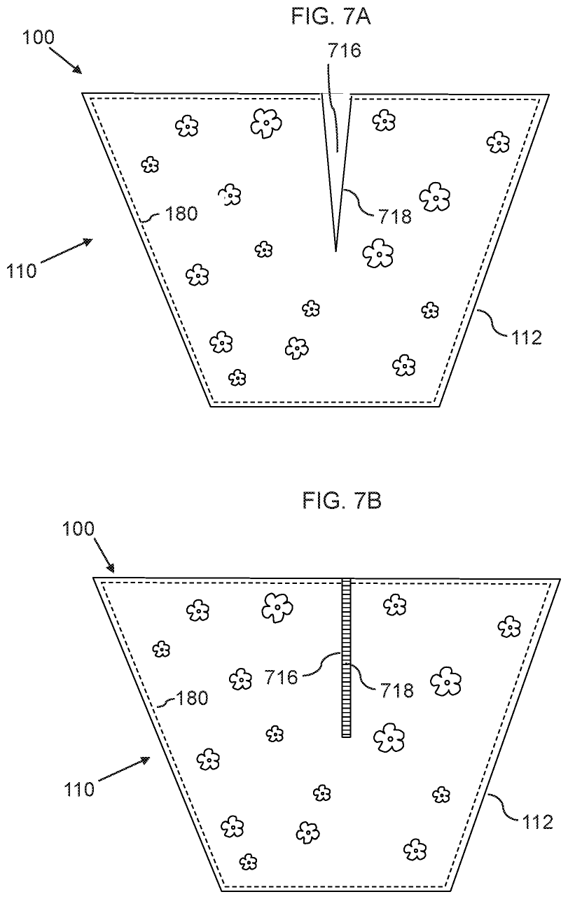

In another related embodiment, as shown in FIGS. 7A and 7B, the sleeve portion 112 of the plant pot cover body 110 can further include:
a) a slit opening 716, which is positioned in an upper part of the sleeve portion 112, such that the slit opening 716 reaches an upper edge of the sleeve portion 112, and
b) an opening fastener 718, for closing the slit opening 716, wherein the opening fastener 718 for example can be:
   i. a plurality of buttons 718;
   ii. a zipper 718; or
   iii. a hook and loop fastener 718;
   such that the slit opening 716 facilitates installation of the plant pot cover body 110, when the slit opening 716 is open, with the opening fastener 718 in an open position, as shown in FIG. 7A; and
   such that the slit opening 716 tightens the plant pot cover body 110, when the slit opening 716 is closed, with the opening fastener 718 in a closed position, as shown in FIG. 7B.

In a related embodiment, the water solution 570 can further comprise
a) water; and
b) a fertilizing agent, which is dissolved in the water;
whereby the fertilizing agent can fertilize a plant, which is planted in the plant pot 180.

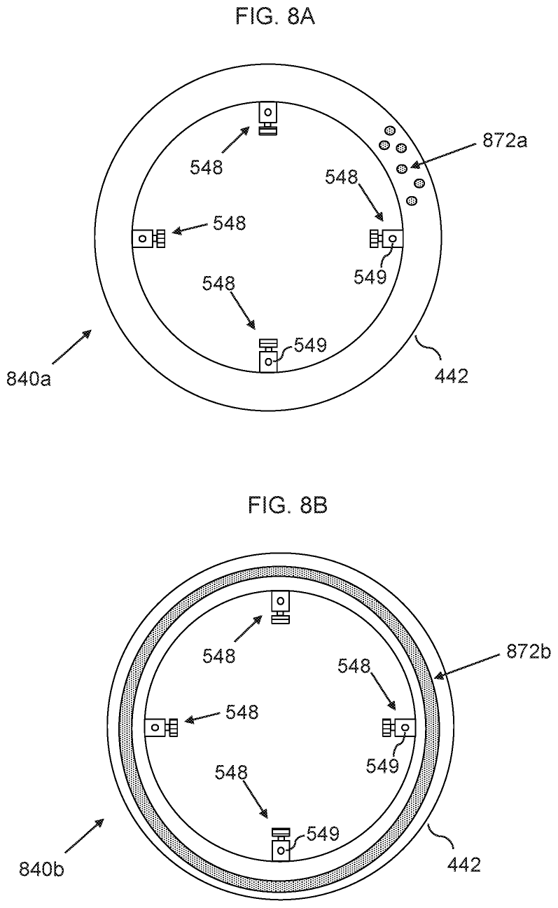

In a related embodiment, as shown in FIGS. 8A and 8B, the watering ring 440 can be configured as a fertilizer ring 840a, 840b, wherein the watering ring 440 can further include:
a) a solid fertilizing agent 872a, 872b, which is positioned inside the hollow tube 442;
whereby the solid fertilizing agent 872a, 872b will gradually dissolve in the water solution 570, such that the water solution 570 can fertilize a plant, which is planted in the plant pot 180.

In a further related embodiment, the solid fertilizing agent 872a, 872b can be configured as a granulate 872a, as shown in FIG. 8A.

In another further related embodiment, the solid fertilizing agent can be configured as a solid fertilizer tube 872b, which is positioned inside the hollow tube 442, as shown in FIG. 8B. The solid fertilizer tube 872b can be ring-shaped, as shown.

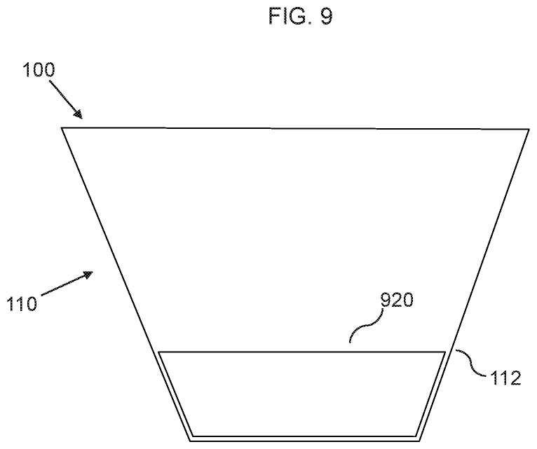

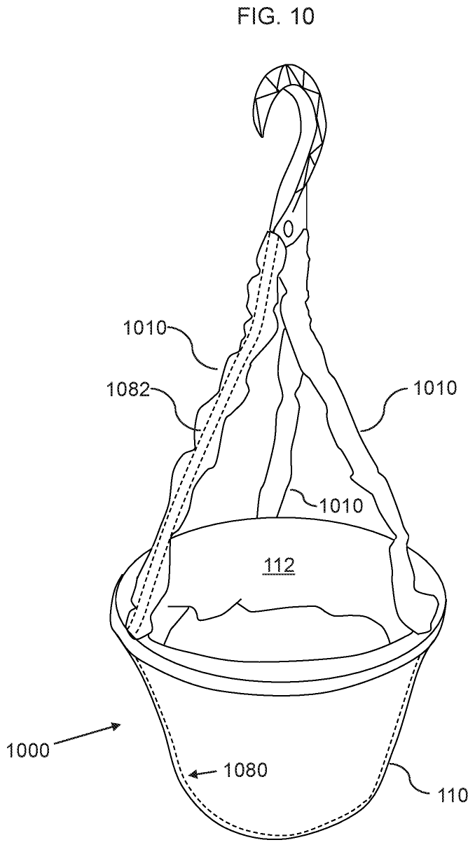

In another related embodiment, as shown in FIG. 9, the plant pot cover system 100 can further include:
a) an inner cup 920, which can be made of plastic, which can be cup-shaped and made of a flexible plastic material, such that the inner cup 920 is watertight;
such that the inner cup 920 can be positioned inside a bottom of the plant pot cover body 110, to maintain a water level inside the plant pot cover body 110, and to prevent dripping of the water solution 570 from the plant pot cover system 100.

In another related embodiment, as shown in FIG. 10, the plant pot cover system 1000 can further include:
a) a plurality of tubular sleeves 1010, which can be made of a flexible/stretchable fabric material, which can be the same material used for the plant pot cover body 110;
such that each tubular sleeve 1010 is configured to slide over a hanger arm 1082 of plant pot 1080, which is configured as a hanging plant pot 1080. FIG. 10 shows that an upper part of the sleeve portion 112 has been folded over an upper rim of the plant pot 1080, similar to what is shown in FIG. 4A.

In various embodiments, the plant pot cover system 100 can be sold as a starter kit 100, and replacement parts can be sold separately. The fertilizer ring 440 may typically need to be replaced every 1-3 months. The plant pot cover body 110 (i.e. decorative sock 110) can be purchased separately and changed out seasonally or when a different design is required. The plant pot cover system 100 can be manufactured in different sizes to fit different size pots 180, such as small, medium and large size. The plant pot cover body 110 can be printed with company names or logos, such that businesses, such as restaurants, have promotional messages on their planters.

Here has thus been described a multitude of embodiments of the . . . device, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A plant pot cover system, comprising:
a plant pot cover body, which is made from a stretchable material, wherein the plant pot cover body comprises:
a sleeve portion, which is tubular;
wherein the plant pot cover body is configured to be pulled over a plant pot, such that the sleeve portion covers a side of the plant pot.

2. The plant pot cover system of claim 1, wherein the plant pot cover body comprises:
a bottom portion, which is connected to a bottom end of the sleeve portion, to close the bottom end of the sleeve portion, such that the bottom portion is configured to cover a bottom of the plant pot.

3. The plant pot cover system of claim 1, wherein the plant pot cover body is coated with an antimicrobial coating, which comprises an antimicrobial agent, whereby the antimicrobial coating inhibits growth of fungi and bacteria.

4. The plant pot cover system of claim 1, further comprising:
an inner lining sleeve, which is waterproof;
such that the inner lining sleeve is configured to be positioned between the plant pot cover body and the plant pot, to waterproof the plant pot cover system.

5. The plant pot cover system of claim 1, wherein the sleeve portion of the plant pot cover body further comprises:
a belt, which is a strengthened peripheral portion of an upper edge area of the sleeve portion.

6. The plant pot cover system of claim 5, wherein the belt is a stitched hem, which comprises a folded back portion of the stretchable material.

7. The plant pot cover system of claim 1, further comprising:
a plurality of cover clips, wherein each cover clip comprises a main clip portion;
such that the main clip portion is configured to hold an upper edge area of the plant pot cover body in position on a rim of the plant pot.

8. The plant pot cover system of claim 7, wherein the main clip portion further comprises:
an outer clip flange; and
an inner clip flange;
such that a top end of the outer clip flange is connected with a top end of the inner clip flange.

9. The plant pot cover system of claim 7, further comprising:
a watering ring, which comprises:
a hollow tube, which is configured to contain a water solution, wherein the hollow tube comprises a plurality of drip apertures;
wherein each cover clip in the plurality of cover clips comprises a ring clip portion, such that the ring clip portion is connected to the main clip portion, such that the ring clip portion protrudes inward from the main clip portion;
such that the ring clip portion is configured to hold a segment of the watering ring, whereby the cover clips are configured to hold the watering ring, when the cover clips are positioned around the rim;
such that the water solution drips from the hollow tube, via the drip apertures, into an interior of the plant pot.

10. The plant pot cover system of claim 9, wherein the watering ring further comprises:
a slip tee fitting comprising an entry aperture, wherein the slip tee fitting is mounted on the hollow tube, such that the water solution is filled into the hollow tube via the entry aperture.

11. The plant pot cover system of claim 9, wherein the watering ring further comprises:
a plurality of adjustable drip fittings, which are positioned in the hollow tube;
wherein each adjustable drip fitting comprises a corresponding drip aperture in the plurality of drip apertures.

12. The plant pot cover system of claim 1, wherein the sleeve portion of the plant pot cover body further comprises:
a) a slit opening, and
b) an opening fastener, for closing the slit opening;
such that the slit opening facilitates installation of the plant pot cover body, when the slit opening is open, with the opening fastener in an open position; and
such that the slit opening tightens the plant pot cover body, when the slit opening is closed, with the opening fastener in a closed position.

13. The plant pot cover system of claim 12, wherein the opening fastener is a zipper.

14. The plant pot cover system of claim 12, wherein the opening fastener is a hook and loop fastener.

15. The plant pot cover system of claim 9, wherein the watering ring further comprises the water solution, which is inside the hollow tube;
wherein the water solution further comprises
a) water; and
b) a fertilizing agent, which is dissolved in the water;
whereby the fertilizing agent is configured to fertilize a plant, which is planted in the plant pot.

16. The plant pot cover system of claim 9, wherein the watering ring further comprises:
a solid fertilizing agent, which is positioned inside the hollow tube;
wherein the solid fertilizing agent is configured to gradually dissolve in the water solution, whereby the water solution is configured to fertilize a plant, which is planted in the plant pot.

17. The plant pot cover system of claim 16, wherein the solid fertilizing agent is configured as a granulate.

18. The plant pot cover system of claim 16, wherein the solid fertilizing agent is configured as a solid fertilizer tube.

19. The plant pot cover system of claim 1, further comprising:
an inner cup, which is cup-shaped and watertight;
such that the inner cup is positioned inside a bottom of the plant pot cover body.

20. The plant pot cover system of claim 1, further comprising
a plurality of tubular sleeves, which are made from the stretchable material;
such that each tubular sleeve in the plurality of tubular sleeves is configured to slide over a hanger arm of the plant pot.
